(19) United States
(12) Patent Application Publication
(10) Pub. No.: US 2026/0214737 A1
(43) Pub. Date: Jul. 23, 2026

(54) METHOD FOR RECONNECTING OVER WI-FI AT LEAST ONE REPEATER TO A HOME GATEWAY AND ASSOCIATED HOME GATEWAY

(71) Applicant: SOFTATHOME, Colombes (FR)

(72) Inventor: Quentin FERABOLI, Nanterre (FR)

(21) Appl. No.: 19/139,982

(22) PCT Filed: Dec. 18, 2023
(86) PCT No.: PCT/EP2023/086399

§ 371 Date: Jun. 17, 2025

(30) Foreign Application Priority Data
Dec. 19, 2022 (FR) FR2213744

(51) Int. Cl. H04W 76/19; H04W 12/037; H04W 12/06; H04W 84/12; H04W 88/16

(52) U.S. Cl. CPC H04W 76/19; H04W 12/037; H04W 12/06; H04W 84/12; H04W 88/16

(57) ABSTRACT

A method for reconnecting over WI-FI at least one repeater to a home gateway the repeater having already been connected at least once to the home gateway is disclosed. The method includes detecting the at least one repeater by the home gateway, the at least one repeater no longer being able to connect to the home gateway; sending encrypted connection data by the home gateway to the at least one repeater; decrypting the connection data by the at least one repeater via a security key; and reconnecting the at least one repeater-(2) to the home gateway-(1) via the decrypted connection data.

### TECHNICAL FIELD

The present invention concerns a Wi-Fi reconnection method of at least one repeater to a home gateway. It also concerns a home gateway configured for Wi-Fi reconnection of at least one repeater to it.

### PRIOR ART

Today, a repeater can connect to a home gateway using the Wi-Fi Protected Setup (WPS) standard, a wireless LAN standard for securely configuring equipment connected to a Wi-Fi terminal. This WPS standard enables Wi-Fi access identifiers to be sent to Wi-Fi equipment (smartphones as repeaters).

If a customer changes the Wi-Fi credentials of their home gateway, the repeater is no longer able to connect, so the customer must restart a WPS association.

The aim of the present invention is to resolve at least one of the cited shortcomings.

### DISCLOSURE OF THE INVENTION

This objective is achieved with a Wi-Fi reconnection method for at least one repeater to a home gateway, the repeater having already been connected at least once to the home gateway. The method according to the invention may also comprise the following steps:
detection of the at least one repeater by the home gateway, the at least one repeater no longer being able to connect to said home gateway,
sending of encrypted connection data by the home gateway to at least one repeater,
decryption of connection data by the at least one repeater via a security key,
reconnect the at least one repeater to the home gateway via the decrypted connection data.

The invention then makes it possible to restore a functional Wi-Fi link between a home gateway and at least one repeater without user action when the home gateway's connection data has been changed and at least one repeater was offline when the connection data was changed. The reconnection of the at least one repeater to the home gateway is automatic. The invention therefore aims to re-pair at least one repeater to Wi-Fi if the latter no longer has the right connection or access data for the home network.

The method may also comprise the following steps:
signature of encrypted connection data by the home gateway before sending to the at least one repeater via a private key of the home gateway,
verification of the signature via a public key of the home gateway by the at least one repeater when receiving the encrypted connection data.

To optimize the security of connections to the home gateway, additional measures such as data signing can be used. The home gateway uses the public key of the at least one repeater to encrypt the connection data and adds a signature using the home gateway's private key. Encrypted and signed connection data is sent to the at least one repeater. The latter verifies the signature with the home gateway's public key, and then decrypts the connection data using the private key of the at least one repeater. Encrypted connection data can be sent via a standardized Wi-Fi frame.

Connection data can be encrypted with a public certificate from the at least one repeater in the standardized Wi-Fi frame.

The security key for decrypting connection data may correspond to a private key of the at least one repeater.

The connection data may correspond to the connection IDs of the home gateway.

In yet another aspect of the invention, a home gateway is proposed, configured for Wi-Fi reconnection of at least one repeater thereto, the home gateway being equipped with a processing unit for implementing the steps of the process according to the invention.

According to another aspect of the invention, also proposed is a computer program comprising instructions which, when the program is executed by a computer, cause the latter to implement the steps of the method according to the invention.

### DESCRIPTION OF THE FIGURES AND EMBODIMENTS

Other benefits and features shall become evident upon examining the detailed description of entirely non-limiting embodiments and implementations, and from the following enclosed drawings:

FIG. 1 shows a flowchart of a reconnection method according to a first embodiment of the invention,

FIG. 2 shows a flowchart of a reconnection method according to a second embodiment of the invention.

These embodiments are in no way limiting, and in particular, it is possible to consider variants of the invention that comprise only a selection of the features disclosed hereinafter in isolation from the other features disclosed (even if that selection is isolated within a phrase comprising other features), if this selection of features is sufficient to confer a technical benefit or to differentiate the invention with respect to the prior art. This selection comprises at least one preferably functional feature which lacks structural details, and/or only has a portion of the structural details if that portion is only sufficient to confer a technical benefit or to differentiate the invention with respect to the prior state of the art.

In general, every home is equipped with a domestic gateway 1. The domestic gateway 1 is usually located in the living room. Home gateway 1 broadcasts a local network. Various repeaters 2 are connected to the home gateway 1 via the local network. The various repeaters 2 in the house are connected to the home gateway 1 via the local network, either wired or wireless. The various repeaters 2 in the home are, for example: reading devices such as a laptop or desktop, a tablet, a cell phone. The user connects the Wi-Fi repeaters 2 to the local network of the home gateway 1 by directly entering the Wi-Fi connection identifiers given by the home gateway 1 on the repeater 2 in question. However, when the user changes the login credentials, for example, all repeaters 2 that were connected to the home gateway 1's local network are automatically disconnected. The process according to the invention is carried out by the processing unit of the home gateway 1.

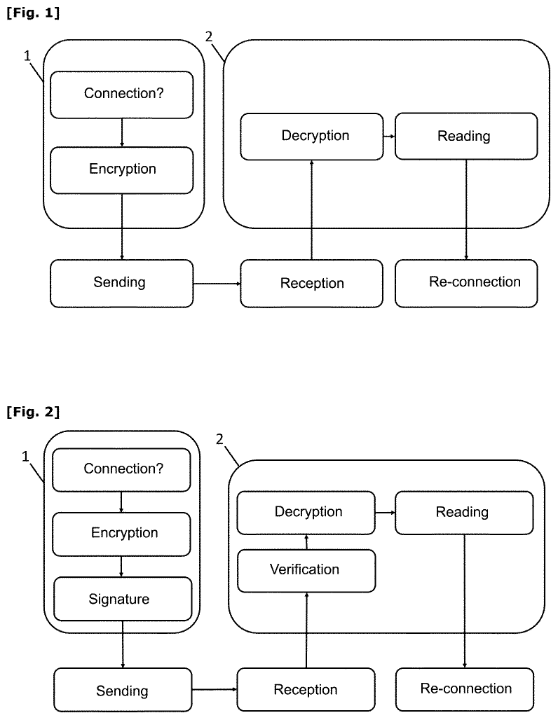

First of all, with reference to FIG. 1, we will describe a flowchart of a reconnection process according to a first embodiment of the invention.

Repeater 2 has already connected to the local Wi-Fi network provided by home gateway 1. However, the user has changed the login details for the Wi-Fi network in question. Repeater 2 is switched off when changing connection identifiers or is offline. Repeater 2 is no longer able to connect to the local network when it is switched back on, or if it is no longer offline.

The repeater 2 scans the environment, preferentially repeatedly, to find its access point. Home gateway 1 can then detect it. When the home gateway 1 detects that the repeater 2 is trying to connect to it, the processing unit encrypts the connection data, that is, the connection identifiers, with the public certificate of the repeater 2 in a standardized Wi-Fi frame or “public action frame”. The public certificate was received by home gateway 1 when repeater 2 was first associated. This standardized Wi-Fi frame is sent to repeater 2 by home gateway 1. The Wi-Fi frame is sent on several Wi-Fi channels so that repeater 2 can receive it.

If home gateway 1 doesn't know repeater 2, it cannot detect it, so repeater 2 must have already connected once to home gateway 1 via the Wi-Fi LAN in order to be able to retrieve the repeater's certificate.

Repeater 2 then receives the Wi-Fi frame and decrypts the connection data with its private key to retrieve the new Wi-Fi connection credentials from home gateway 1. Repeater 2 reads the connection data. Reconnection to the Wi-Fi network of home gateway 1 is then automatic with the new connection credentials. Thus, this mechanism enables a functional Wi-Fi link to be restored between a home gateway 1 and a repeater 2 without any action on the part of the user. There is no limit to the number of repeaters 2 for simultaneous connection.

We will now describe, with reference to FIG. 2, a flowchart of the method of the invention according to a second embodiment of the invention.

The method in this embodiment operates in the same way as that shown in FIG. 1 with the only difference that it includes additional steps such as:
the encrypted connection data is signed by the home gateway 1 before being sent to the repeater 2 via a private key of the home gateway 1, the signature is verified via a public key from home gateway 1 by repeater 2 when it receives the encrypted connection data.

When it first connects to the Wi-Fi network of home gateway 1, repeater 2 retrieves the public certificate of home gateway 1, giving it access to the public key of home gateway 1 for subsequent signature verification.

Typically at least one of the means of the device according to the invention previously described, preferably each of the means of the device according to the invention previously described, are technical means.

Typically, each means of the device according to the invention previously disclosed may comprise at least one computer, a central processing or computing unit, an analog electronic circuit (preferably dedicated), a digital electronic circuit (preferably dedicated), and/or a microprocessor (preferably dedicated), and/or software means.

Of course, the invention is not limited to the examples just described, and many adjustments can be made to these examples without going beyond the scope of the invention.

Of course, the various features, forms, variants and embodiments of the invention may be combined with each other in various combinations as long as they are not incompatible or exclusive of each other. In particular, all the variants and embodiments described above can be combined with each other.

1. A method for Wi-Fi reconnection of at least one repeater to a home gateway, the repeater having already been connected at least once to the home gateway, the method comprises the following steps:
detection of the at least one repeater by the home gateway, the at least one repeater no longer being able to connect to said home gateway the home gateway sends encrypted connection data to at least one repeater;
decryption of connection data by the at least one repeater via a security key; and
reconnection of the at least one repeater to the home gateway via the decrypted connection data;
signature of encrypted connection data by the home gateway before sending to the at least one repeater via a private key of the home gateway; and
verification of the signature via a public key of the home gateway by the at least one repeater when receiving the encrypted connection data.

2. The reconnection method according to claim 1, wherein the encrypted connection data is sent via a standardized Wi-Fi frame.

3. The reconnection method according to claim 2, wherein the connection data is encrypted with a public certificate of the at least one repeater in the standardized Wi-Fi frame.

4. The reconnection method according to claim 1, wherein the security key for decrypting the connection data corresponds to a private key of the at least one repeater.

5. The reconnection method according to claim 1, wherein the connection data correspond to connection identifiers of the home gateway.

6. A home gateway configured for Wi-Fi reconnection of at least one repeater thereto, the home gateway being equipped with a processing unit for implementing the process steps according to claim 1.

7. A computer program product comprising instructions which, when the program is executed by a computer, cause it to implement the steps of the method according to claim 1.
